(19) United States
(12) Patent Application Publication
(10) Pub. No.: US 2023/0115791 A1
(43) Pub. Date: Apr. 13, 2023

(54) METHOD AND SYSTEM FOR IDENTIFYING ASSETS AND AUTOMATING THE CREATION AND MONETIZATION OF ADVERTISEMENTS

(71) Applicant: TLYNT Inc., Los Angeles, CA (US)

(72) Inventors: Sameer Gupta, Las Vegas, NV (US); Johnathan Richard, Los Angeles, CA (US); Lisa Maria Cabrera, San Gabriel, CA (US)

(21) Appl. No.: 17/957,163

(22) Filed: Sep. 30, 2022

Related U.S. Application Data
(60) Provisional application No. 63/255,141, filed on Oct. 13, 2021.

(51) Int. Cl. G06Q 30/02

(52) U.S. Cl. CPC G06Q 30/0276; G06Q 30/0277; G06Q 30/0273

(57) ABSTRACT

A system and method are configured to identify advertising assets and automate the creation and monetization of advertisements using such assets. Information regarding advertising assets from a variety of asset providers is collected and stored in a database. Advertisers provide information regarding themselves and desired advertising assets, such as based upon criteria for an advertisement to be created. The advertiser and/or advertisement information is used to identify or match relevant assets, such as by searching tags which identify aspects or characteristics. An advertiser may selects identified assets, with the system generating one or more sample advertisements using those assets and providing payment to the provider of the asset.

### RELATED APPLICATION DATA

This application claims priority to U.S. Provisional Patent Application Ser. No. 63/255,141, filed Oct. 13, 2021, and incorporates by reference said application as if set forth fully herein.

### FIELD OF THE INVENTION

The present invention relates to identifying assets and automating the creation and monetization of advertisements using such assets

### BACKGROUND OF THE INVENTION

While many advances have been made in the digital advertisement industry, the traditional advertisement industry, which includes but is not limited to print, television, radio and billboards, has not advanced at the same rate. Sourcing assets, including but not limited to people, places, pets and objects, is a relatively manual process which involves the compilation of images, a manual selection process, the coordination with talent and/or owners, and an onerous payment process. Sometimes the cost of the resources necessary to find, book, manage and pay for an asset (for example a non-union firefighter for a commercial TV shoot) approaches or exceeds the cost of the asset itself. Advertisers use a combination of agencies and casting companies, which in turn find other companies that can assist in the sourcing of assets, including people, places, pets and objects. On top of the costs for one or more companies to do this work, the time it takes can be considerable. For example, if a business is looking for 20 “real people” talent (a.k.a. average persons that are non-union actors) for a commercial, that business may spend 10 to 100 hours at a cost of $100 to $500 per hour, equaling $1,000 to $50,000, when the cost of the talent is only $20,000 (20 times $1,000). In other cases, advertisers pay a flat commission of 20% of more for this task, which often involves sifting through Dropbox folders of pictures of people and emailing/texting/speaking to agencies. The asset pool is limited in size and difficult to manage. Meanwhile there are millions of people in the “gig economy” that are interested in being in a commercial and getting paid for their time and service.

Additionally, conventional methods of advertisement content creation may not be able to benefit from current advances in digital technology. Conventional advertisements are storyboarded, reviewed in focus groups, and created in a similar manner to decades ago. There is no easy way to get a sample advertisement into the digital market to test its efficacy before spending substantial money in the creation of the ad. Think of a main actor in a commercial. Before being cast, the actor must either be a celebrity with a known engagement, or a risky newcomer who the creative team “believes in” but has little data to support their prominent role until after the commercial airs.

Lastly, the content creation process is timely and expensive. Making a new advertisement of any type takes time and resources including but not limited to creative agencies, graphics designers, actors and real people talent, shoot locations, props, audio-video equipment and editing software. In a world withe apps that allow for the quick-and-easy creation of semi-professional photographs, we are still creating ads like we were before digitization: by hiring people to create storyboards of concepts, which are approved through focus groups and the opinions of stakeholders, and are then produced at substantial cost before being disseminated through multiple advertising channels.

A system and method to better source assets, testing content, and create advertisements is desired.

### SUMMARY OF THE INVENTION

Embodiments of the invention comprise systems and methods for identifying advertising assets and automating the creation and monetization of advertisements using such assets.

One embodiment of a method for providing advertising assets to an advertiser, comprises the steps of: storing, in a database which is associated with a server, information regarding a plurality of advertising assets which are associated with asset providers; receiving, at the server, data regarding the advertiser and data regarding at least one target asset; retrieving auxiliary data related to the advertiser; generating one or more advertisement requirements based on the data regarding the advertiser and the auxiliary data related to the advertiser; comparing the one more advertisement requirements to the advertising assets to determine whether one or more advertising assets meet one or more of the advertisement requirements; causing information regarding one or more of the advertising assets that are determined to meet the advertising requirements to be displayed; receiving input of a selection of at least one of the displayed advertising assets; and providing payment to the asset provider associated with each selected advertising asset.

One embodiment of a system comprises a server comprising a processor, a memory, and machine-readable code stored in the memory and executable by the processor, a database which is associated with the server, and digital information stored in the database, the information regarding a plurality of advertising assets which are associated with asset providers, where the machine-readable code is configured to receive information from an advertiser regarding the advertiser and an advertising project, to generate asset search criteria and search the database for relevant assets, to identify relevant advertising assets, and to generate one or more graphical representations of advertisements using selected advertising assets.

Further objects, features, and advantages of the present invention over the prior art will become apparent from the detailed description of the drawings which follows, when considered with the attached figures.

### DESCRIPTION OF THE DRAWINGS

FIG. 1 illustrates an exemplary environment of use of an automated advertisement system;

FIG. 2 is a flow diagram of methods of embodiment of the automated advertisement system from the advertiser-end;

FIG. 3 is a flow diagram of methods of embodiment of the automated advertisement system from the asset provider end using passive matching;

FIG. 4 is a flow diagram of methods of embodiment of the automated advertisement system from the asset provider end using active search; and

FIGS. 5-8 are exemplary user interfaces.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The present invention is an automated advertisement system and method to streamline the advertisement creation process using artificial intelligence (“AI”) and other technology. Specifically, advertisers with a need to create one or more advertisements may be automatically matched to asset providers who may provide assets to be used in the advertisement. The automated advertisement system may also create and optimize advertisements with iterative redesign based on quantifiable market feedback and payments to assets based on digital contracts like non-fungible tokens.

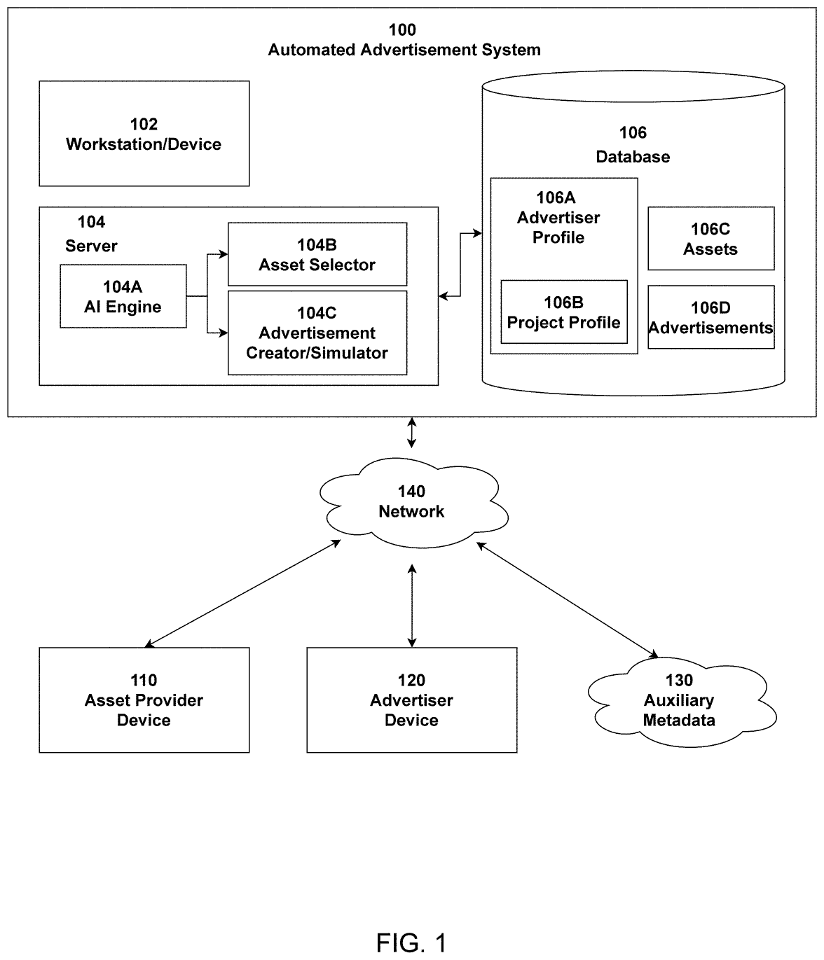

FIG. 1 illustrates an exemplary environment of an automated advertisement system in connection with advertisers and asset providers. In FIG. 1, an automated advertisement system 100 may be in communication with a number of advertiser devices 110 and asset provider devices 120, via a network 130 (such as the Internet). Advertiser devices 110 and asset provider devices 120 may be any user device such as a smartphone, a tablet, a smartwatch, a personal computer, or any other type of electronic computing device. Additional resources such as auxiliary data and metadata 140 on websites, servers, database, or clouds may also be accessible via the network 130.

The automated advertisement system 100 may include a plurality of workstations and user devices 102, at least one server 104 which comprises one or more processors or controllers, at least one communication device or interface, a database or other data storage device 106, and one or more additional memory or data storage devices (such as separate from the database). In one or more embodiments, the processor(s) is configured to execute one or more instructions, such as in the form of machine readable code (i.e. “software”), to allow the server 104 to perform various functions. The software is preferably non-transitory, such as by being fixed in a tangible medium. For example, the software may be stored in the one or more memory devices. One or more of the memory devices may be read-only. In addition, the software may be stored on a removable medium in some embodiments. In general, the one or more memory devices are used as temporary storage. For example, the one or more memory devices may be random access memory or cache memory used to temporarily store some user information and/or instructions for execution by the at least one processor.

The software may comprise one or more modules or blocks of machine-readable code. Each module may be configured to implement particular functionality when executed by the one or more processors, and the various modules may work together to provide overall integrated functionality. Of course, in certain embodiments, it is also possible for various of the functionality to be implemented as hardware, i.e. a processor or chip which is particularly designed to implement various of the functionality described herein.

In one embodiment, the server 104 may include (or be linked communicatively at one or more times to) one or more input and/or output devices, such as a keyboard, mouse, touchscreen, video display or the like, whereby the processor may receive information from an operator or servicer of the server 104 and/or output information thereto. This allows, for example, an operator of the server 104 to interface with the server 104 to upgrade, maintain, monitor, etc. In other embodiments, an operator might interface with the server 104 via a separate workstation or other devices 102.

In one embodiment, the processor and other elements of the server 104 may be linked and thus communicate over one or more communication buses. In this manner, for example, the processor may read/receive software from the memory for execution, receive inputs and provide outputs to the various I/O devices, receive information from or output information to external devices via the communication interface, etc. The one or more communication devices or interfaces permit the server 104 to communicate with the one or more workstations and devices 102, and preferably external devices, networks, systems and the like.

The automated advertisement system 100 may, via server 104 (there may be a plurality of different servers which each implement different functionality) be configured to implement a variety of functionality, including but not limited to account matching, advertisement creation, data gathering and analysis, and payment processing. These features will be discussed in more detail below. The automated advertisement system 100 may include a wide variety of other features and elements, including but not limited to an accounting system, a user tracking system, a reporting system, and the like.

The automated advertisement system 100 allows advertisers to efficiently create advertisements by simplifying the underlying asset sourcing, selection and iterative creation process, and allows advertisers to automatically create advertisements or concepts for advertisements that are optimized through artificially-intelligent testing of the ads on digital and traditional ad platforms

As indicated, the automated advertisement system 100 comprises a database 106, which may include at least one database or dataset including, but not limited to, advertiser profiles 106A, project profiles 106B, assets 106C, and advertisements 106D. In one embodiment, project profiles 106B may be a database or dataset within the advertiser profiles 106A database or dataset.

In one embodiment, assets 106C comprise a database of assets for use in creating advertisements. The assets may comprise, for example, images, sound files, videos and the like. As described in more detail below, the assets may be provided (such as uploaded) by one or more asset providers and/or may be collected from one or more sources, such social media accounts of asset providers.

As further described below, the assets which are associated with the database 106 may be tagged with one or more tags. The tags may comprise identifiers or information, such as may be searched with a search engine. For example, the tags may comprise information which identifies the asset, such as by type (person/animal/object), and various sub-types or categories (male/female; hair color, hair style, etc.). As described below, the tags may also comprise time and/or location stamps. The timestamps may include a time that the asset was created (e.g. when a photo or video was taken), and/or the time the asset was associated with the database 106. The location stamp may include a location at which the asset was created (such as associated with a photo or video when taken). The time and/or location stamps may be automatically generated and associated with an asset (such as a photo taken with a smartphone; wherein the times information may be extracted from the photo) or might be added, such as manually. For example, where a photograph does not include embedded location information, the asset provider might be prompted to input location information by the system 100.

In one embodiment, the tag may be created from information provided by the asset provider. For example, if an asset provider uploaded an image of their dog, the asset provider might provide identifying information such as: dog/Labrador/black/male/puppy. In other embodiments, the server may be configured to generate tag information. For example, the server may apply image analysis to an image in order to obtain information from the image which is used to tag the asset. In this manner, a comprehensive database 106 of advertising assets is generated, where the assets are, in the manner described below, searchable and usable in the generation of one or more advertisements. Further, in that the assets are provided by asset providers, advertisers can readily use the assets associated with the database without having to individually locate and clear or obtain approval to use, assets in the advertisement.

As further illustrated in FIG. 1 and described in more detail below, the automated advertisement system 100 may implement, such as by the server 100, an AI engine 104A, which may comprise one or more modules including but not limited to an asset selector 104B and an advertisement creator/simulator 104C. The asset selector 104B may be configured to match data in the advertiser profile 106A and/or the project profile 106B to data in assets 106C. The advertisement creator/simulator 104C may be used to create and/or simulate advertisements using the selected asset from the asset 106C database or database, and such created and/or simulated advertisements may be stored in the advertisements 106D database or database.

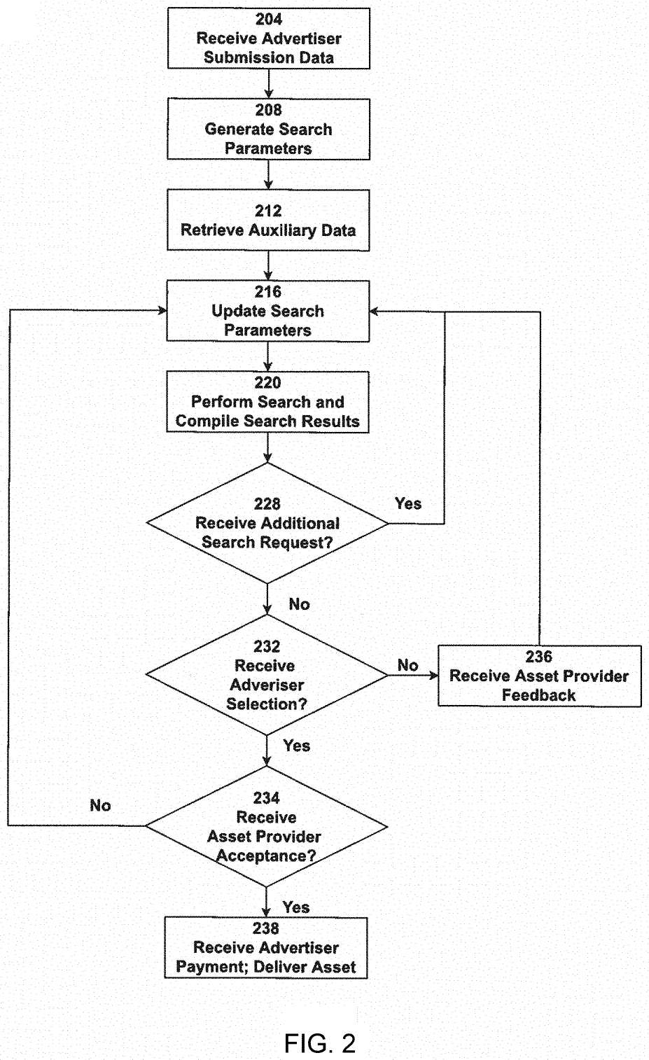

FIG. 2 is a flow diagram of one exemplary method of the automated advertisement system 100 from the advertiser-end. An advertiser may be any individual or entity in need of an advertisement. Such an advertisement may include any form of media requiring an asset. Assets may be in any form of media, including but not limited to videos, images, audio, etc., and may include a variety of subjects, including but not limited to humans, animals, objects, locations, properties, etc. For example, an advertiser may want to create a video-format pet shampoo advertisement and may require a video of an animal to represent the pet and a video of a human to represent the pet owner. The advertiser may also wish to obtain images of the animal and human for a promotional poster, and audio files of the animal and human for a promotional radio advertisement. The video and radio advertisements may also include audio assets, such as dialogue, music or the like. In another example, an advertiser may want to promote a travel agency, and may want to obtain assets in the form of images of various locations a tourist may wish to travel to.

In a step 204, an advertiser may connect with the automated advertisement system 100 via an advertiser device 110 to enroll in an advertiser account, and to submit data. Data may include information for a general advertiser profile, including but not limited to profile information (such as name, location, payment accounts etc.), official websites and company profiles, and social media accounts. Data may also include information for an advertisement project, including but not limited to the nature of the advertisement, the intended audience, the specific requirements for assets, etc.

In one embodiment, in addition to a general advertiser profile, the advertiser may create one or more project profiles. A project profile may include information, such as criteria for, a particular advertising project. For example, an advertiser might create a first project profile for a dog shampoo advertisement, and a second project profile for a cat food advertisement. Each of these advertisements might have different associated criteria. In one embodiment, the automated advertisement system 100 may use the advertiser's profile, past project profiles, and/or auxiliary data to auto populate and/or suggest one or more criteria in new projects, and may predict and/or suggest assets.

In a step 208, general search parameters may be generated based on the submitted data. This data might comprise: 1) the project profile data, 2) the advertiser's profile data, and/or 3) other or tertiary information, such as information regarding any past projects the advertiser may have created and stored in the automated advertisement system database 106. In a step 212, auxiliary data may be retrieved. In a step 216, auxiliary data may be used to update search parameters.

As discussed in FIG. 1, the automated advertisement system 100 may access auxiliary data and metadata 130 via the network 140. Auxiliary data may include any information related to the advertiser. In the example of a pet shampoo company in search of assets for a pet shampoo advertisement, auxiliary data may include the pet shampoo company's social media profiles, company connection graph, customer profiles, social media information, company profiles containing news and press releases, searches in news and other information databases for news relating to the pet shampoo company, and any other type of publicly available information. For example, where the specific requirement for an asset representing a pet owner may not include specifications for the actor's age, but where a recent press release indicates the company is actively promoting pet products towards older customers, the search parameters may be updated to weight search results for assets involving older actors differently than assets involving younger actors.

In one embodiment, projects may have profiles with attributes that may be self-selected and automatically created through analysis of advertiser data and behavior. For example, an advertiser may be a company in the healthcare industry who wishes to create a project for an advertising campaign for an insurance plan. The project profile may include, but is not limited to, data such as date(s), time(s), location, assets sought and budget. The advertiser may optionally link its social media accounts. Attributes may be automatically added and/or updated for the project profile and/or the advertiser profile through analysis of the advertiser's social media, digital footprint including company website, news articles, other online mentions, and associated pictures, videos and text about the company. Further, attributes may be automatically added and/or updated for the project profile and/or the advertiser profile through analysis of the advertiser's use of the automated advertisement system 100, such as how long the advertiser views each asset's profile, which assets the advertiser has shortlisted, held or been booked, and the advertiser's rating by the assets it has booked.

In a step 220, one or more searches may be performed in the database 106 to identify available and matching assets, and search results may be displayed to the advertiser. Where multiple types of assets are requested (such as a pet and a pet owner), more than one search may be performed and one more than set of results may be displayed.

The search results may be displayed using a gamified optimization algorithm, so that the advertiser may see assets not in the order of best-to-worst results (based on matching of specific requirements), but instead, in an order that maximizes the probability that the advertiser finds one or more assets they will choose and/or maximizes the feeling of success in using the system.

In one embodiment, the system may generate an initial set of search results, such as 5-10 search results. The advertiser may select or reject individual search results. As the advertiser selects or rejects individual search results, the results may be updated to include new/additional results. For example, assume that the advertiser is looking for images of a dog. A first set of images may be presented. The advertiser may reject the first image of a white dog, but select second and third images of black dogs. Based upon the advertiser's indications, the system may be configured to supplement or update the results to include additional images of black dogs and/or remove images of white dogs.

In another embodiment, an advertiser may be permitted to select a particular asset and then see all related assets. For example, an advertiser may select from the search results an image of a black Labrador puppy. The advertiser might select a “see related” feature to see all assets of that same puppy, such as other images of the puppy (taken in different locations, at different times), videos of the puppy, etc. As another example, an advertiser might be permitted to select a particular asset and then see all similar assets. For example, an advertiser may select from the search results an image of a black Labrador puppy. The advertiser might select a “see similar” feature to see all assets of black Labrador puppies (including ones other than the selected one).

In an optional step 228, the advertisers may refine the search (such as via the submission of additional data, as described in step 204). An asset compilation module may be configured (based on default settings or user preference settings) to display assets individually, or compiled in a pre-made advertisement form (such as a brief video showing a pet owner giving the pet a bath using shampoo). In the latter case, the advertiser may be given the option to isolate portions of the pre-made advertisement. The isolated portion may be designated as a selected asset, and the user may request additional results to be displayed for the non-selected assets. In another embodiment, the isolated portion may be used to refine searches. For example, the advertiser may isolate the pet in the pre-made advertisement and request a search for similar pets. The advertiser may also manually input additional search criteria such as “a similar-looking dog, but with white fur”.

Alternatively, in a step 232, the advertiser may identify that no assets are usable. In a step 236, the advertiser may be prompted to provide feedback to refine the search. For example, the advertiser may identify that all the results for pet assets may be cats (based on the advertiser's auxiliary data), and submit a request that, for this project, dogs are desired.

If the advertiser identifies one or more assets as usable, then in a step 236, the asset provider is notified of the advertiser's request to use the asset. For example, upon identifying the desired dog asset, the asset provider may be the dog owner, who may be notified of the advertiser's request to use that asset and be given the opportunity to reject the request. If the asset provider rejects the advertiser's request, then the search results may be further refined to remove that particular asset, or all assets by that particular asset provider.

If, on the other hand, the asset provider accepts, then in a step 238, payment may be delivered to the asset provider, and the asset is delivered to the advertiser. In one embodiment, the advertiser may make special requests for assets to an asset provider. For example, if the advertiser wishes to create an advertisement poster for an animal shampoo using the front view of a dog's face, and identified a desired dog asset, but the asset is a side-view of a dog, the advertiser may request the asset provider provide a front view image of the dog instead. In another embodiment, the advertiser may request alternative searches be performed on the asset provider's social media to identify existing images of the dog, and to retrieve an image involving the front view. In one embodiment, assets may be delivered to the advertiser by transmitting them to the advertiser. In another embodiment, the assets may simply be associated with the advertiser's account (e.g. linked from the database 106 to the advertiser's account as having been accepted/paid for, and thus usable by, the advertiser). In other embodiments, the asset may be associated with one or more advertisements which are provided to or accessible by the advertiser.

Many steps in this flowchart may be iterative. For example, steps 212 to 216 may be repeated as many times as needed, such that new auxiliary data may be periodically retrieved, and search parameters may be updated in real time, particularly if the advertisement project is on-going, or the advertiser has not obtained all the asset the advertiser needs for the advertisement project. Steps 216 to 228 may be repeated as many times as needed until an advertiser stops requesting additional searches. Steps 216 to 236 may be repeated as many times as needed until an advertiser finds a desired compilation of search results.

The automated advertisement system allows asset providers to quickly and easily create profiles for themselves or property they own (including but not limited to places, pets and objects) that are available through an online digital marketplace for advertisers and their agents to find. The profiles can include social media accounts which show the assets in more natural settings with timestamps so that interested parties can get a more realistic view of the asset over time and into the present. The automated advertisement system allows asset providers to choose open projects to apply to, which are ranked based on an artificially-intelligent algorithm which matches the asset to the project, and weights the matches. The matches are shown using a gamified optimization algorithm, so that the user may see projects not in highest-to-lowest matching, but instead in an order that maximizes the chance the user finds one or more projects to apply to and/or maximizes the feeling of success in using the system.

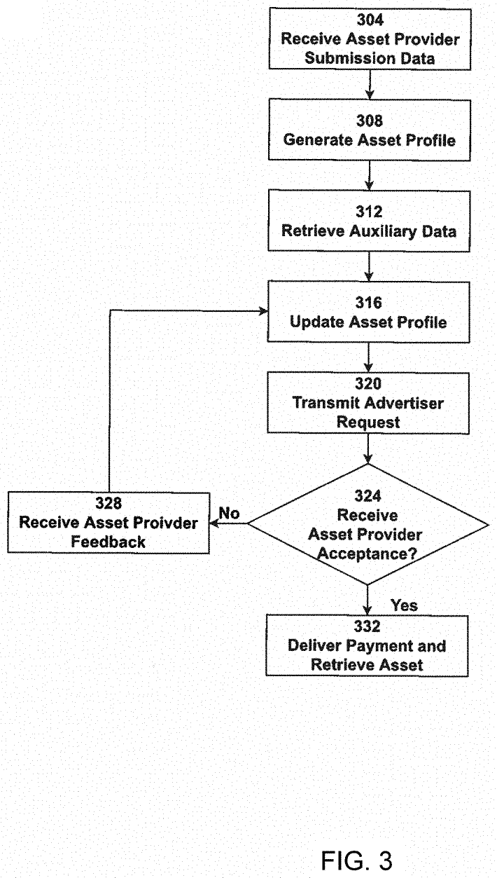

FIG. 3 is a flow diagram of an exemplary method of the automated advertisement system from the asset provider end using passive matching. In a step 304, an asset provider may connect with the automated advertisement system 100 via an asset provider device 120 to enroll in an asset provider account, and to submit data. Data may include information for a general asset profile for each asset the provider wishes to provide, including but not limited to profile information (such as asset name, asset category, asset location, etc.) and one or more displays of the asset, which may include any form of media (such as image, video, audio), as well as social media accounts. In one embodiment, the asset provider may manually select identification tags for the assets (such as the following tags for a dog video: “dog”, “animal”, “video”). The asset provider may also select restrictions for advertisers (such as a dog video only be used in advertisement created by advertisers identified as cruelty-free).

In a step 308, a general asset profile may be generated based on the submitted data. In a step 312, auxiliary data may be retrieved. In a step 316, auxiliary data may be used to update search parameters. On the asset end, auxiliary data may include any information related to the asset or asset provider. For example, if the asset is an Instagram model, auxiliary data may include images and videos retrieved from all social media accounts identified with the Instagram model, as well as other social media posts or news history associated with the asset. The asset's profile may be updated with such additional images and videos and their respective timestamps to display the asset in a plurality of environments, to provide a more realistic view of the asset, as well as any changes over time. Any negative news may be identified for advertisers who submitted specific requests for public image or perception. For example, an Instagram model identified with controversial political views may not be matched with advertisers or advertisement projects with specific requests for assets with no public controversies. Steps 312 to 316 may be iterative such that auxiliary data may be periodically retrieved, and the asset profile may be updated in real time, for as long as the asset is identified as available for matching.

In one embodiment, asset account profiles may include attributes that may be self-selected or automatically created through analysis of the asset's data and behavior. For example, an asset may be a 65-year-old man from Los Angeles, who created an asset account with links to his social media accounts. He may select one or more attributes, including but not limited to his height and weight. The automated advertisement system 100 may gather, through analysis of auxiliary metadata such as the asset's social media pictures and videos, additional asset attributes (such as hair color), or further refine the attributes (such as the asset's current weight based on his latest social media posts, compared to the weight an asset may have selected at the time of account registration). The asset's hobbies, interests, work, favorite topics and social manner may also be analyzed through analysis of his social media. Additionally, the asset's use of the automated advertisement system 100 may be analyzed to further supplement his attributes, including how long the asset looks at each project, which project he has been shortlisted for, held or been booked, and his rating by the projects he has booked.

In a step 320, if the asset is matched with an advertisement project and selected for use, a request to use the asset may be transmitted to the asset provider. In a step 324, the asset provider may reject the request. In a step 328, upon rejection, the advertiser may be notified that the asset is not available, and the advertiser's search results may be updated to remove the asset, or all assets by the asset provider submitting the rejection. At the same time, the asset profile may be updated to no longer be matched with similar-type advertisers or advertisement projects, or the asset provider may manually input additional criteria to refine future matching.

If, on the other hand, the asset provider accepts the request, then in a step 332, payment may be delivered to the asset provider, and the asset may be retrieved and delivered to the advertiser. In one embodiment, the asset provider may permit automatic retrieval of the asset without confirmation of acceptance, in which case steps 320 to 328 may be skipped.

Depending on the asset provider's settings and/or the advertiser's request, an asset may be used only in one advertisement project or only by one advertiser (such as purchasing an NFT or any other type of exclusive right), or an asset may be used in multiple advertisement projects or by multiple advertisers.

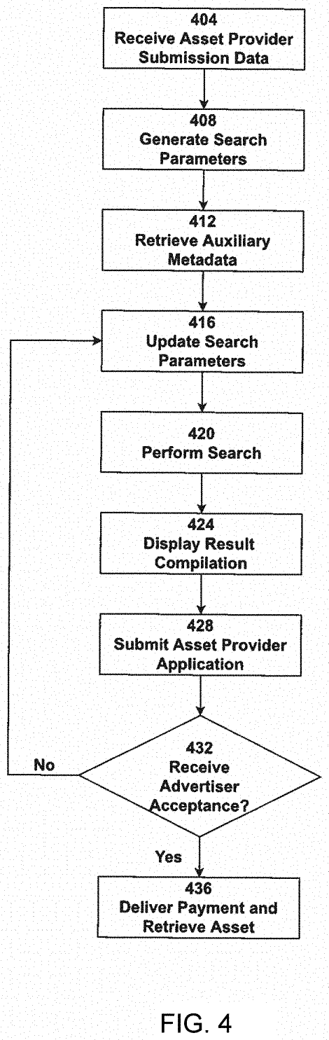

FIG. 4 is a flow diagram of an exemplary method of the automated advertisement system from the asset-end using active search. In contrast to the passive search discussed in FIG. 3, an asset provider may also perform active searches for matching advertisement projects. In a step 404, an asset provider may establish an asset profile as discussed in steps 304-316 above. In a step 408, the asset provider may submit additional data for a search. For example, where an asset provider established an asset profile for an image or video of a dog, the asset provider may request a search for all advertisers in need of dog assets. In a step 408, general search parameters may be generated based on the submitted data and any past projects the asset may have been used in. In a step 412, auxiliary data may be retrieved. In a step 416, auxiliary data may be used to update search parameters.

Auxiliary data may include any information related to the asset provider or the asset. For example, based on the asset provider's social media use, the asset provider may be identified as an advocate for animal rights. Search parameters may thus be updated to weight search results for advertisers identified as cruelty-free differently than advertisers not identified as such.

In a step 420, one or more searches may be performed in the database 106 to identify available and matching advertisement projects, and search results may be displayed to the asset provider. In one embodiment, the search results may also be displayed using a gamified optimization algorithm (as discussed in FIG. 2 step 220).

In a step 428, the asset provider may identify one or more advertisement projects that are desirable, and may submit an application for the advertiser to use the asset. In a step 432, the asset provider may reject the application, in which case, the search parameters in may be updated to remove the advertisement project or all projects by the advertiser from matching. If, on the other hand, the advertiser accepts, then in a step 436, payment may be delivered to the asset provider, and the asset may be delivered to the advertiser.

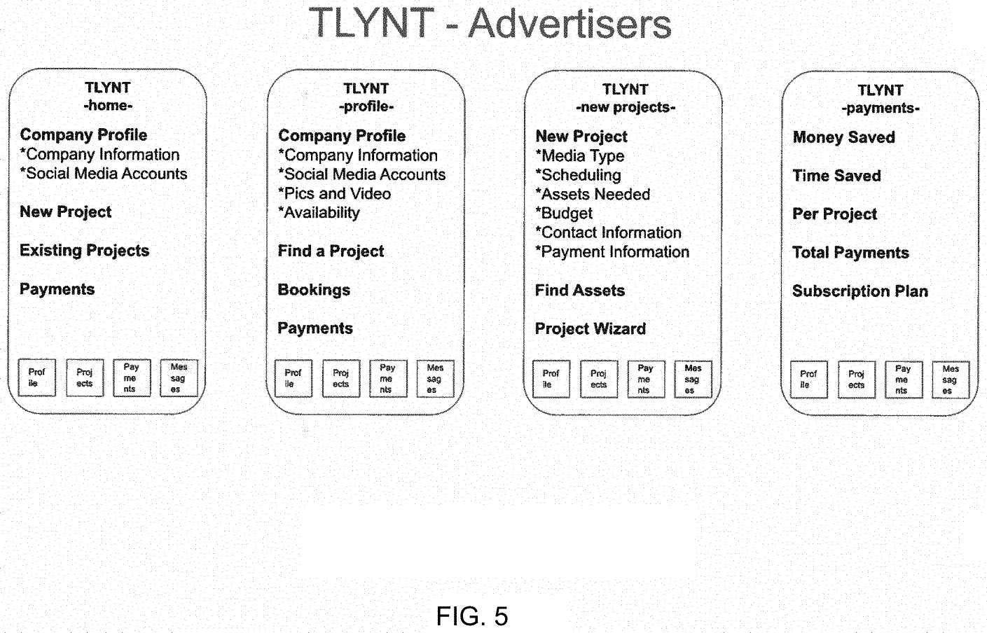

FIG. 5 illustrates exemplary user interfaces for an advertiser account. Notably, advertisement projects may be sorted by a plurality of options including but not limited to media type (such as image, video, audio, etc.), scheduling, assets needed, and budget.

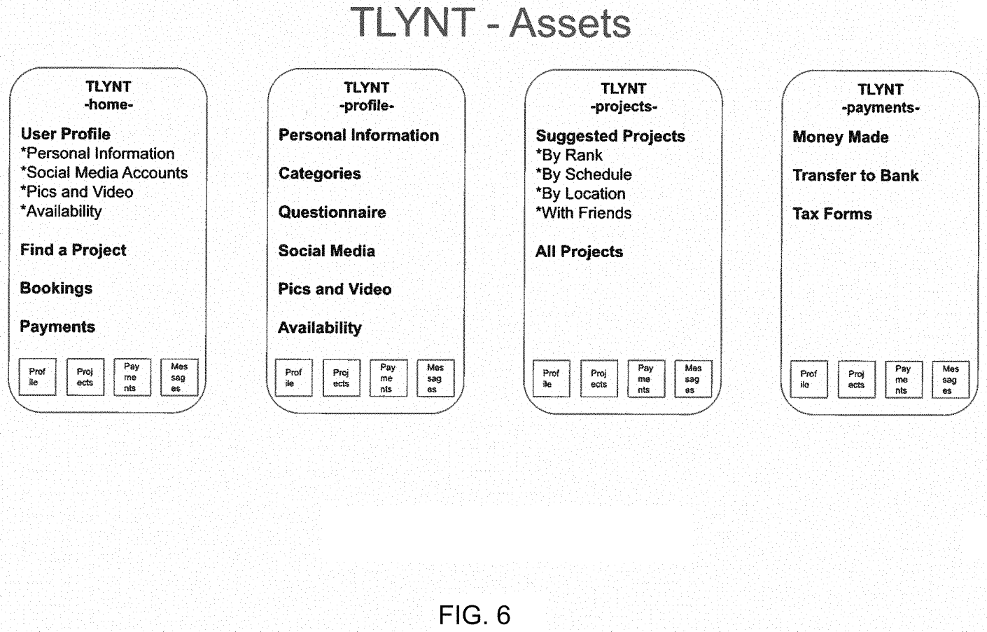

FIG. 6 illustrates exemplary user interfaces for an asset provider account. In addition to the passive and active matching illustrated in FIGS. 3 and 4, the asset provider account may include a “Suggested Projects” page, which may automatically display matching advertisement projects, and may be sorted by a plurality of options.

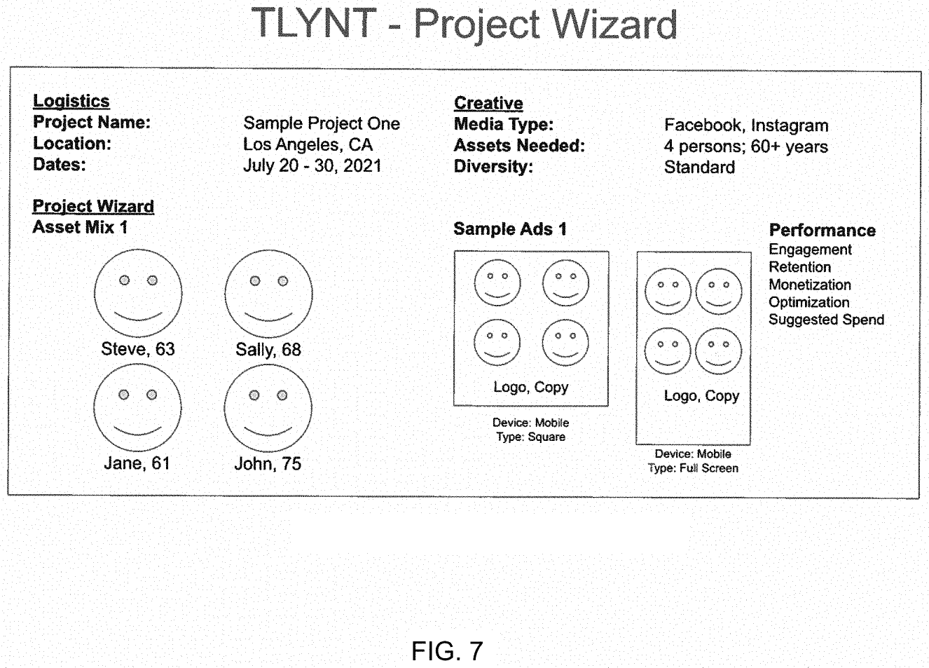

FIG. 7 illustrates exemplary user interface for advertisement creation (“Project Wizard”), which may be accessible via one or more advertiser account pages. The user interface may include one or more advertisement samples and/or digital storyboards, which may be automatically generated using default templates, or may be customized for advertisers. In one embodiment, the digital storyboard may include one or more options for assets, such that an advertiser may selection and/or mix and match assets. One or more project profile summaries may be displayed above the asset options. Advertisers may save entire storyboards, or asset mixes (selection and/or combination of desired assets), or save individual elements of the asset mixes.

In one embodiment, asset mixes may be iteratively created and optimized by individual asset performance in digital campaigns (including but not limited to the performance of an individual asset, a combination of more than one assets, as used in previous advertisements, and/or assets' social media reach). The asset mixes may include information of such past performance so that advertisers may use that information to inform creative decisions and budgets.

Advertisers may also rate each element of the asset mix. Such ratings may be used to update one or more matching and/or searching algorithms used by the AI engine 104 and/or the automated advertisement system 100.

In one embodiment, asset mixes may be automatically added to digital advertisement templates, and digital agreements may be automatically generated and/or processed (discussed below), to create fully licensed advertisements that may be distributed online.

The Project Wizard may be fully integrated with one or more news, website, or social media platforms, and may use auxiliary data from the integrated sources to optimize advertisement templates. As shown in FIG. 7, for example, where an advertisement project identifies its primary audience as Facebook and Instagram, a performance rating may be assigned to the sample advertisement and its underlying assets, which may rate the sample based on a number of performance categories including but not limited to user engagement, audience retention, viability for monetization, and level of optimization. Performance ratings may be generated based on existing data of similar advertisement projects, assets, and general user data.

The advertiser may modify the advertisement sample, and the performance ratings may be updated in real time based on such modifications. Based on the performance ratings, the Project Wizard may also make one or more recommendations, such as a suggestion for lower spending due to limited monetization options.

Using digital graphics technology, such as including augmented reality software, selected assets may be digitally combined in a manner that makes it appear that they appeared together in a photo or video shoot. In this respect, individually selected assets are preferably combined or assembled, to create an advertisement. The configuration of the advertisement may depend, for example, on the project profile or other information. For example, based upon the project profile identify the project as a still image advertisement involving a dog getting shampooed in a outdoor tub, the assets might comprise a video of a dog getting shampooed, an image of a steel water tub, an image of a backyard, and one or more children. The video may be modified so that the dog appears to be standing in the tub, in the back yard, with the children in the area. In some embodiments, templates or layouts may be selected and utilized to aid in the creation of the advertisements, including the association of the assets. Preferably, the server 104 is configured to automate the creation of the sample advertisement using the assets.

As discussed previously, where an advertiser retrieves an image from an asset on a social media platform (such as the front view of a dog in a posted picture on Instagram), the advertisement creation tool may isolate the asset from the background to be used in the advertisement sample. Assets may also be digitally manipulated (such as digitally altering a model's age, turning real images into cartoon images, creating virtual 2D or 3D backgrounds). Thus, a plurality of advertisements can be created using the set of assets, but customized to appeal to different demographics, then tested on social media and digital ad platforms to determine the engagement of each.

For example, where the advertiser may wish to create an animal shampoo advertisement, one advertisement may be created using the asset of a native image of a man in his mid-30s representing the pet owner for an advertisement to be published on Twitter, where the user demographic may be identified as having an average age of 30. A second advertisement may be created using the same asset, but digitally modifying the image to appear as a man in his mid-50s for an advertisement to be published on Facebook, where the user demographic may be identified as having an average age of 50.

In one embodiment, the Project Wizard may automatically begin simulating one or more advertisement projects as the advertiser is creating the project profile using suggested assets based on existing search criteria. Each additional search criteria the advertiser enters may result in modifications to the simulation, such that the advertisement creation process becomes dynamic, and suggested assets may inspire further creation and/or modification to a simulated advertisement.

In one embodiment, upon creation, proper licensing, and publication of the created advertisement, the advertisement may distributed through digital campaigns, with engagement, retention and monetization of each campaign informing the rating for each asset mix. The ratings for each asset mix are, in turn, used to update the weights for the individual assets and relationship between the asset and the project (discussed more below).

Further, the performance rating may be converted to real-time tracking of statistics associated with the advertisement (such as actual user engagement, audience retention, etc.). These new statistics may, in turn, be used to calibrate performance ratings for future advertisement projects. Further, the highest performing advertisements may be identified for the advertiser, who may wish to reshoot the advertisement by professionals to add additional “polish” to the product, with the knowledge from the user engagement data that their target audience resonates with the underlying assets and overall presentation.

Where the advertiser and/or the asset provider provided social media accounts, depending on user settings, created advertisements may be automatically pushed to their respective social media accounts as a new post, or the advertiser and/or the asset provider may be provided with customizable links or templates to create their own social media posts. The newsfeed templates may include social media tags or handles of all parties involved. For example, the advertiser's Twitter account may publish a Tweet with an embedded advertisement video, as well as links to the Twitter account of all models used in the video. Similarly, the models' Twitter accounts may publish a Tweet with the embedded advertisement video, as well as links to the Twitter account of other models and the advertiser. The respective followers of each Twitter account may then be able to “re-tweet” the newsfeed, thereby spreading the advertisement video across a wide network of Twitter accounts.

Thus, the advertisement may be promoted on social media networks associated with multiple user accounts, thereby maximizing exposure. Further, the promoted advertisement will not only promote the advertiser's product or services, but also the assets used in the advertisement, thereby benefitting all parties involved and incentivizing active participation.

The asset providers may not only receive exposure from the advertisement itself, but may be further incentivized to help promote the advertisement by receiving a portion of the advertisement revenue based on exposure traceable to the asset provider's promotional activities.

Simultaneously, the promoted advertisement may include watermarks or links to the automated advertisement system 100, thereby promoting the system itself.

In addition, the automated advertisement system 100 streamlines the licensing process of creating an advertisement. Electronic contracts and non-fungible tokens can be used to track the relationships over time, including the ads that are created, to pass value based on terms agreed to by the users. Through user acceptance of terms and services, and the automated delivery of any additional legal documents, the automated advertisement system 100 may create advertisements with underlying rights secured.

The automated advertisement system 100 may be used to create advertisements for social media platforms, live streaming platforms, content creation and publication platforms, email marketing campaigns, etc. Advertisements may be made in any media form including but not limited to images, videos, audios, pop-up promotions, website banners, etc.

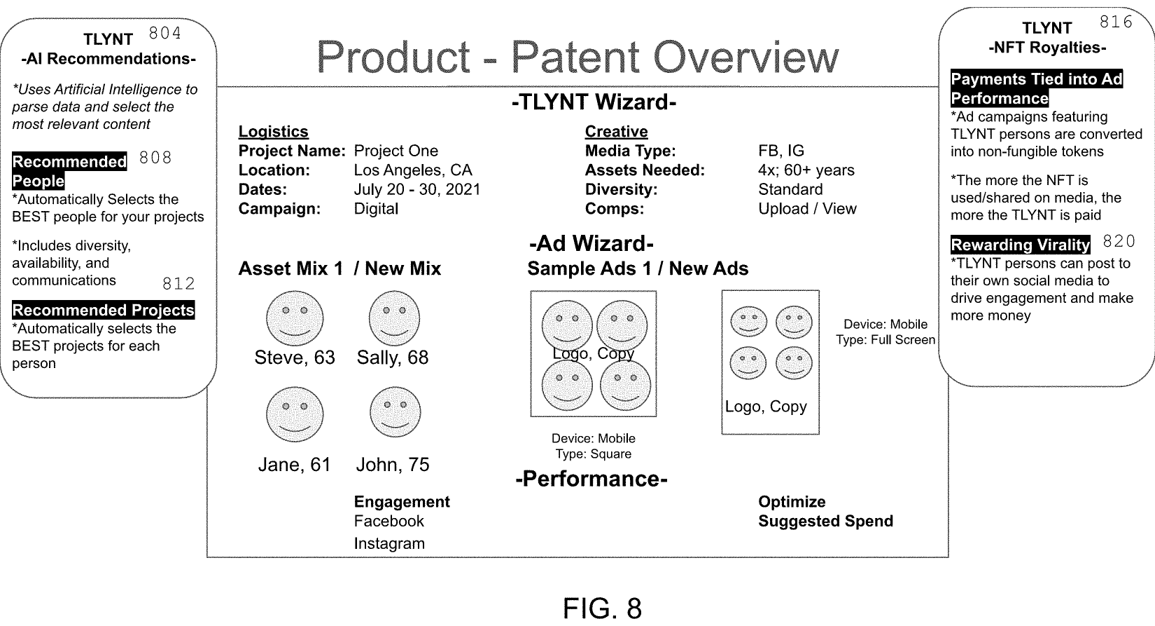

FIG. 8 illustrates exemplary user interfaces for the AI recommendation page and the NFT royalties page. In one embodiment, one or more AI engines (illustrated as 104A in FIG. 1 and discussed above) and/or AI modules may be used to parse data and select the most relevant content for any user. Such relevant content may appears on an AI recommendation page 804, which may begin to auto populate with project and asset recommendations based on an advertiser's input of one or more search criteria. One or more AI engines (illustrated as 104A in FIG. 1 and discussed above) and/or AI modules may be used to parse data and select the most relevant content.

For advertisers, the AI recommendation page 804 may include recommendation for assets 808. Asset recommendation may be based on asset attributes (discussed above) that match the project attributes (discussed above) of the projected created by the advertiser. Such attributes may include but are not limited to attributes such as demographics, work/hobbies/interests, reliability, physical appearance, recent photographs and videos, social media reach, diversity, availability, and locations. Specifically, the one or more AI engines or AI modules may assign a weight for each asset relative to a project. These weights may change over time, as informed by the profile changes in the projects and assets, and informed by the interaction between the project and asset. For example, a project may request a questionnaire, survey or interview from an asset. The results of that interaction may impact the asset-to-project weighting. If the weight of an asset indicates the asset is suitable for the project, then the asset may appear on the AI recommendation page 804. As discussed previously, a gamified optimization algorithm may be used to determine which assets may be recommended.

Similarly, for asset providers, the AI recommendation page 804 may include recommendation for projects based on the dynamic weight of projects relative to an asset 812.

As discussed above, assets may be in any electronic or digital format. Where an asset is a non-fungible token (NFT), the advertisement created with such NFT assets (whether the advertisement itself may be an NFT or not) may be added to the blockchain to allow for tracking of engagement and payment to underlying assets (such as in the form of royalties, as discussed above).

For example, a digital advertisement may be created with a first NFT asset and a second NFT asset. The asset provider of each NFT asset may, via a digital agreement, which may be provided by the automated advertisement system 100 and may include but is not limited to any type of licensing agreement, assignment, or other types of transfer of rights, grant the advertiser of the digital advertisement the rights to use the asset. The digital agreement may include the terms for payments for each NFT asset (such as, for example, a payment of $10 to the asset provider of the first NFT asset per thousand views of the digital advertisement, and a payment of one large bag of pet food to the asset provider of the second NFT asset per thousand views of the digital advertisement). The digital agreement may be added to the blockchain.

The digital advertisement may be distributed through organic and paid placement on digital distribution channels such as on social media and websites, or via press releases and interviews. The automated advertisement system 100 may measure the engagement of each ad using its one or more AI engines or modules, and/or using third party data (such as Facebook Insights providing performance of an advertisement on Facebook). Information related to the engagement may then be attached to the blockchain for the digital advertisement, and may be used to calculate payment to the asset providers pursuant to the digital agreement.

In one embodiment, the advertisement itself may created as an NFT, and may be added to the blockchain to allow for tracking of engagement and payments.

As discussed above, asset providers may use their own efforts to push engagement numbers higher for advertisements using the assets provided by the asset providers. Such efforts may include but are not limited to buying copies of the advertisement, promoting the advertisement on their own social media accounts, and/or arranging their own press releases or interviews.

Appendix A illustrates additional exemplary user interfaces of the automated advertisement system 100 for advertisers and asset providers.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method for providing advertising assets to an advertiser, comprising the steps of:
storing, in a database which is associated with a server, information regarding a plurality of advertising assets which are associated with asset providers;
receiving, at said server, data regarding said advertiser and data regarding at least one target asset;
retrieving auxiliary data related to said advertiser;
generating one or more advertisement requirements based on said data regarding said advertiser and said auxiliary data related to said advertiser;
comparing said one more advertisement requirements to said advertising assets to determine whether one or more advertising assets meet one or more of said advertisement requirements;
causing information regarding one or more of the advertising assets that are determined to meet said advertising requirements to be displayed;
receiving input of a selection of at least one of the displayed advertising assets; and
providing payment to said asset provider associated with each selected advertising asset.

2. The method in accordance with claim 1, wherein said advertising assets comprise one or more media files.

3. The method in accordance with claim 2, wherein said media files comprise images or videos.

4. The method in accordance with claim 1, wherein said step of receiving data regarding said advertiser comprises receiving input of said data from said advertiser, and wherein said step of receiving auxiliary data related to said advertiser comprises obtaining information regarding said advertiser indirectly.

5. The method in accordance with claim 4, wherein said auxiliary data is obtained from a website, social media site, or a news or media feed.

6. The method in accordance with claim 1, wherein one or more tags are associated with each advertising asset and said step of comparing comprises comparing said one or more advertisement requirements to said tags.

7. The method in accordance with claim 1, further comprising the step of receiving information from said asset provider regarding said one or more tags associated with a provided advertising asset and/or generating said one or more tags based at least in part of an analysis of said advertising asset.

8. The method in accordance with claim 1, further comprising transmitting, from said server to an advertiser device, a media comprising said advertising asset selected by said advertiser.

9. The method in accordance with claim 1, wherein said information regarding said one or more advertising assets that are determined to meet said advertising requirements is displayed on a device of said advertiser.

10. The method in accordance with claim 1, wherein said one or more advertising assets are determined to meet said advertisement requirement if at least some of said advertising requirements are met.

11. The method in accordance with claim 10, wherein said one or more advertising assets which are determined to meet said advertisement requirements are displayed in a hierarchy of relevance.

12. The method in accordance with claim 1, further comprising receiving input from said advertiser of a request for information regarding advertising assets related to at least one of said displayed advertising assets.

13. The method in accordance with claim 1, further comprising the step of generating a sample advertisement using said one or more selected advertising assets and causing said sample advertisement to be displayed.

14. The method in accordance with claim 1, wherein said data regarding at least one target asset comprises information regarding an advertisement and one or more assets to be used in said advertisement.

15. The method in accordance with claim 1, wherein said data regarding at least one target asset comprises information regarding a desired advertisement of said advertiser.

16. A system for associating advertising assets with an advertiser and associated advertisement, comprising:
a server comprising a processor, a memory and machine-readable code stored in said memory and executable by said processor;
a database which is associated with said server;
digital information stored in said database, said information regarding a plurality of advertising assets which are associated with asset providers;
said machine-readable code configured, when executed by said processor of said server, to cause said server to:
receive data regarding said advertiser and data regarding at least one target asset;
retrieve auxiliary data related to said advertiser;
generate one or more advertisement requirements based on said data regarding said advertiser and said auxiliary data related to advertiser;
compare said one more advertisement requirements to said advertising assets to determine whether one or more advertising assets meet one or more of said advertisement requirements;
cause information regarding one or more of the advertising assets that are determined to meet said advertising requirements to be displayed;
receive input of a selection of at least one of the displayed advertising assets; and
retrieve said selected advertising asset from said database and generate a graphical representation of an advertisement utilizing said selected advertising asset.

17. The system in accordance with claim 16, wherein said machine-readable code is configured to implement an AI engine, said AI engine configured to compare said advertisement requirements to said advertising assets.

18. The system in accordance with claim 16, wherein said machine-readable code is configured to retrieve auxiliary data by transmitting one or more requests for information to one or more third party websites.

19. The system in accordance with claim 16, wherein said advertisement is created using a template with which said selected advertising asset is associated.

20. The system in accordance with claim 16, wherein said digital information regarding said advertising assets comprises one or more tags.
